(19) United States
(12) Patent Application Publication
(10) Pub. No.: US 2016/0181014 A1
(43) Pub. Date: Jun. 23, 2016

(54) SURFACE-MOUNT INDUCTOR AND METHOD FOR MANUFACTURING THE SAME

(71) Applicant: TOKO, INC., Tsurugashima-shi (JP)

(72) Inventors: Ryota WATANABE, Tsurugashima-shi (JP); Takeo OHAGA, Tsurugashima-shi (JP); Hiroyasu MORI, Tsurugashima-shi (JP); Yasutaka MIZUKOSHI, Tsurugashima-shi (JP); Takumi ARAI, Tsurugashima-shi (JP); Masaaki TOTSUKA, Tsurugashima-shi (JP); Kunio SASAMORI, Tsurugashima-shi (JP)

(21) Appl. No.: 14/972,965

(22) Filed: Dec. 17, 2015

(30) Foreign Application Priority Data
Dec. 20, 2014 (JP) 2014-258141

(51) Int. Cl. H01F 41/02; H01F 27/29; H01F 41/06; H01F 27/28

(52) U.S. Cl. CPC H01F 41/02; H01F 27/2828; H01F 27/292; H01F 41/0246; H01F 41/0616

(57) ABSTRACT

A surface-mount inductor including: a coil formed by winding insulated wire and bringing out lead ends therefrom; and a plurality of premolded bodies for accommodating the coil inside, thereby thermopressing to form, wherein a pair of metal terminals is embedded laterally on the outer surface of the surface-mount inductor, and the lead ends of the coil are brought out from the bottom surface of the surface-mount inductor and laterally laid on the outer surface of the metal terminals, as well as a method for manufacturing the same.

### CROSS-REFERENCE TO RELATED APPLICATION

This application is based upon and claims the benefit of priority from the prior Japanese Patent Application No. 2014-258141, filed on Dec. 20, 2014, the entire contents of which are incorporated herein by reference.

### BACKGROUND OF THE INVENTION

1. Field of the Invention

The present invention relates to a surface-mount inductor and a method for manufacturing the same.

2. Description of the Related Art

As shown in JP2010-245473 (patent document 1), an inductor having a coil embedded in magnetic resin, which is a mixture of magnetic powder and resin, has been widely used. A molded coil which is embedded in magnetic resin is configured as a surface-mount inductor which is built by forming electrodes for mounting on a printed wiring board. The electrodes being made by painting an electric conductive paste which is made by dispersing metal particles such as Ag in thermosetting resin such as epoxy resin, or adhering metal terminals to the molded coil.

### SUMMARY OF THE INVENTION

### Problem to be solved by the Invention

As the electric conductive paste is expensive, it is costly to apply it over a large area. Thus, metal plates are widely used instead as external terminals of large-size surface-mount inductors. Methods for manufacturing such surface-mount inductors are disclosed in JP2010-087240 (patent document 2) and JP2011-054713 (patent document 3), for example.

The patent document 2 discloses a method for manufacturing a surface-mount inductor in which a molded coil is formed by embedding a coil in magnetic resin with exposed lead ends brought out therefrom, preliminarily folding metal terminals in a predetermined shape, attaching the metal terminals to the molded coil, and electrically connecting the lead ends and the metal terminals by soldering or welding.

The patent document 3 discloses another method for manufacturing a surface-mount inductor in which lead ends and metal terminals are connected by soldering or welding, the lead ends and a part of a metal plate including the connecting portion thereof are embedded in magnetic resin to form a molded coil, the metal plate exposed from the molded coil being folded along the outermost turn of the molded coil to form metal terminals.

The method for manufacturing the surface-mount inductor in the patent document 2 has some issues. One of them is the large size of the surface-mount inductor due to the metal terminals being mounted after the completion of the coil. The size of the inductor varies with the thickness of the metal terminals. Another issue is the terminals falling off due to the adherence of the adhesive being deteriorated when soldering the metal terminals onto the molded coil.

Further, the method for manufacturing the surface-mount inductor in the patent document 3 has a problem in that the portion connecting the metal terminals and the lead ends is embedded in the molded coil so that it is not possible to visually confirm the connecting state.

### Means for Solving the Problem

A surface-mount inductor according to the present invention is characterized by a surface-mount inductor including: a coil formed by winding insulated wire and bringing out lead ends therefrom; and a premolded body formed by thermopressing into a form a mixture of magnetic powder and thermosetting resin to accommodate the coil whose lead ends are brought out therefrom; comprising

a pair of metal terminals made of deformable plates, and arranged on the outer exposed surface of the premolded body; and

a coil the lead ends of which are embedded at the outer exposed surface.

A method for manufacturing a surface-mount inductor according to the present invention is characterized by the steps of:

mixing magnetic powder and thermosetting resin so as to produce a combination-type premolded body of predetermined shape; and

preparing a coil formed by winding an insulated wire, accommodating the coil in the combination-type premolded body with the lead ends of the coil brought out therefrom, arranging the metal terminals on the outer surface of the premolded body, arranging the lead ends on the outer surface of the metal terminals, and thermopressing the premolded body into form.

### Effect of the Invention

According to the surface-mount inductor of the present invention, a surface-mount inductor may be manufactured without using any adhesive, thus metal terminals do not fall off since the metal terminals are partially embedded in the resin. And, the portion connecting the metal terminals and the lead ends is exposed on the surface of the surface-mount inductor so that the connecting state may be visually confirmed.

### BRIEF DESCRIPTION OF THE DRAWINGS

FIG. 1 is a broken perspective view showing the structure of a surface-mount inductor according to the present invention.

FIG. 2 is a development view of the metal terminals in the structure of FIG. 1.

FIG. 3A through FIG. 3F show steps in the manufacturing process of the surface-mount inductor according to the present invention.

FIG. 4A is a cross sectional view of the surface-mount inductor before the forming process according to the present invention.

FIG. 4B is a cross sectional view of the surface-mount inductor after the forming process according to the present invention.

FIG. 5 is an enlarged cross sectional view of the surface-mount inductor according to the present invention.

FIG. 6 is a photograph showing a cross sectional view of the surface-mount inductor according to the present invention.

### DETAILED DESCRIPTION OF THE INVENTION

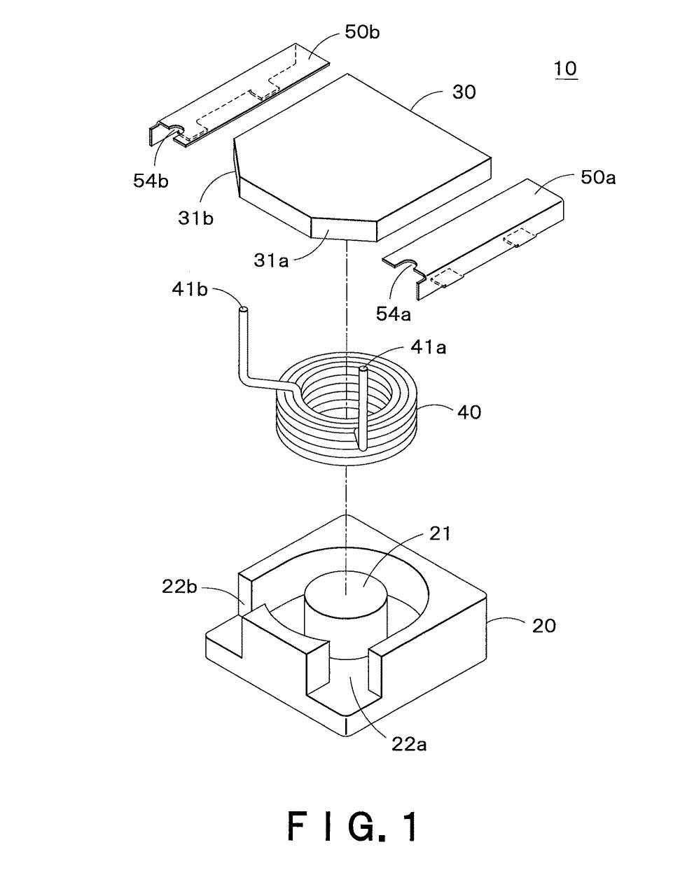

The surface-mount inductor according to the present invention is described below, referring to FIGS. 1-6.

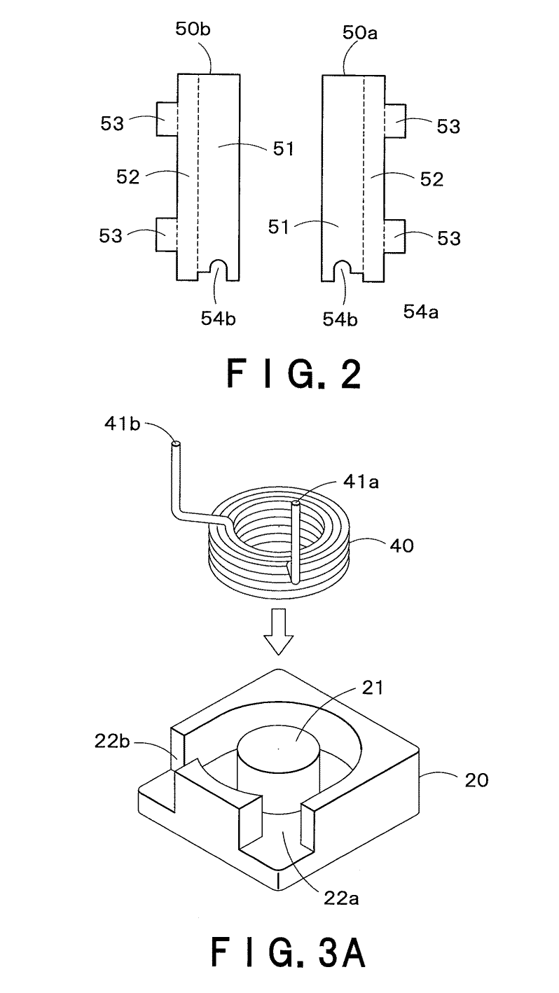

FIG. 1 is an exploded perspective view from bottom up describing the structure of the surface-mount inductor of the present invention, and FIG. 2 is a development view of the metal terminals in the structure of FIG. 1.

The surface-mount inductor 10 includes: premolded bodies 20, 30 formed by pressure forming magnetic resin, which is a mixture of magnetic powder and thermosetting resin such as epoxy resin; coil 40 formed by winding an insulated wire; and a pair of metal terminals 50a, 50b formed by punching a thin metal plate and by folding in a predetermined shape which are connected with both of the lead ends 41a, 41b, respectively.

The premolded body 20 has a rectangular parallelepipedic profile, a cylindrical pot-like space inside, and a protruded portion 21 provided at the center of the bottom surface inside the space. The premolded body 20 has an E-shaped longitudinal section, and the outer wall thereof is partially cut out at the corners to make open portions 22a, 22b.

The premolded body 30 fitted with the premolded body 20 is substantially rectangular in plan view and the corners 31a, 31b are chamfered.

The coil 40 is wound to be cylindrical in shape, and the lead ends are brought out from the outermost turn in radial directions outwardly and folded about 90° in the direction of the center axis of the coil 40.

As shown in FIG. 2, the metal terminals 50a and 50b consisting of a metal plate having an L-shaped cross section, includes: a bottom surface 51; and a side surface 52 formed by folding at 90° along the broken line close to the center. The side surface 52 has tongue-like embedding portions 53 formed by folding at 90° in the same direction as that of the bottom surface 51 at the position indicated by the other broken line closer to the end, and a cutout 54a at the lower part in FIG. 2. The metal terminals 50a and 50b are symmetrical, with the metal terminal 50b having a cutout 54b similarly to the metal terminal 50a.

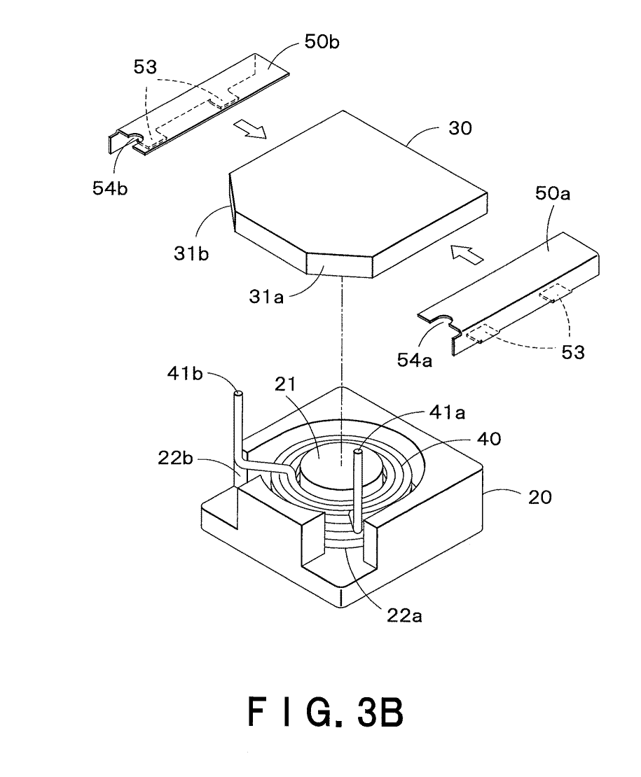

The method for manufacturing the surface-mount inductor according to the present invention is described referring sequentially to FIGS. 3A through 3F.

FIG. 3A: The coil 40 is accommodated in the premolded body 20 in a manner that the lead ends 41a, 41b are placed at the open portions 22a, 22b.

FIG. 3B: The metal terminals 50a, 50b are arranged at both sides of the premolded body 30 in a manner that the corner portion 31a is in line with the cutout 54a and the corner portion 31b is in line with the cutout 54b, respectively.

FIG. 3C: The premolded body 30 is overlapped with the premolded body 20 in a manner that the lead ends 41a, 41b are brought out from the cutouts 54a, 54b of the metal terminals 50a, 50b.

FIGS. 3D, 3E: The lead ends 41a, 41b brought out from the premolded body 30 are folded at the base portions 42, 42 which are exposed from the premolded body 30, and arranged along the upper surface of the metal terminals 50a, 50b. The surface-mount inductor in FIG. 3E is referred to as “pre-formed surface-mount inductor 10A” hereinbelow.

FIG. 3F: The pre-formed surface-mount inductor 10A is thermopressed (“forming” hereinbelow) in the mold to form “formed surface-mount inductor 10B (before connecting to terminals)”.

Processing the formed surface-mount inductor 10B by dip soldering, the insulation layer of the lead ends 41a, 41b are removed and at the same time the lead ends 41a, 41b and the metal terminals 50a, 50b are electrically connected to form the surface-mount inductor 10 as a formed article. Here, dip soldering may be replaced by thermocompression bonding.

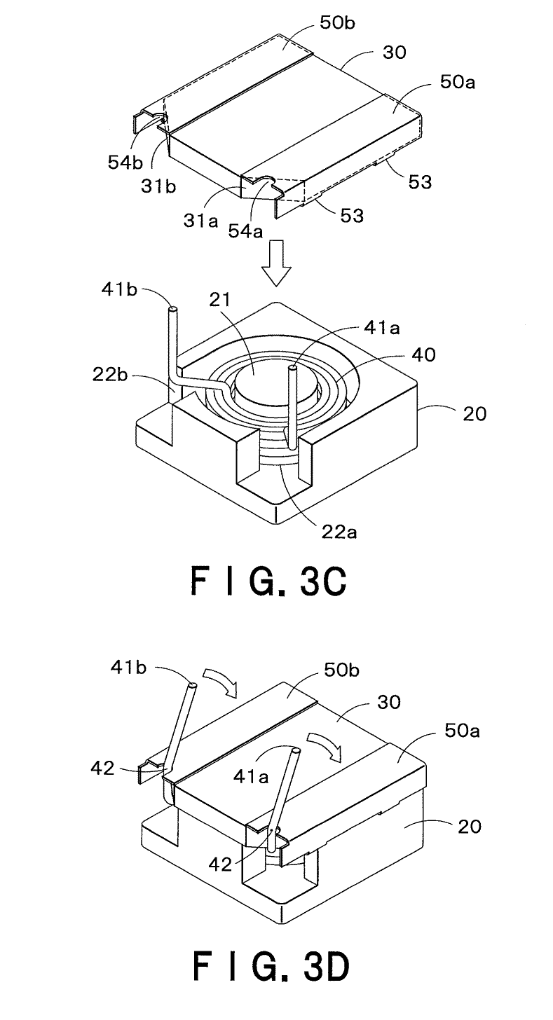

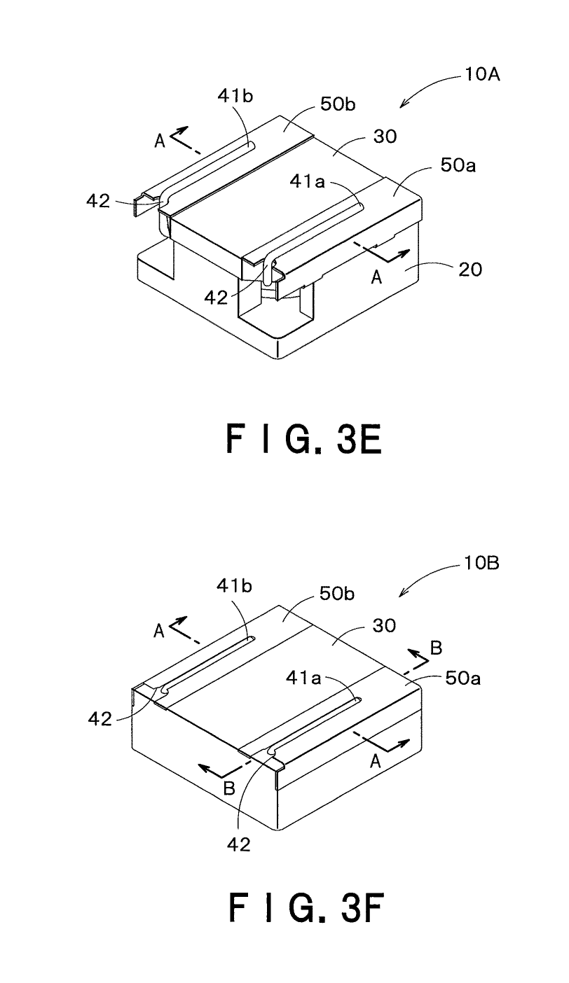

FIG. 4A is a longitudinal sectional view of the pre-formed surface-mount inductor 10A (along section A-A in FIG. 3E), and FIG. 4B is a longitudinal sectional view of the formed surface-mount inductor 10B (along section A-A in FIG. 3F).

As shown in FIG. 4A, the pre-formed surface-mount inductor 10A has the lead ends 41a, 41b mounted on the metal terminals 50a, 50b, and there are vacant spaces 60 between the coil 40 and the premolded bodies 20, 30 and vacant spaces of the open portions 22a, 22b (FIG. 1, FIG. 3A-3E) inside the premolded bodies 20, 30.

As shown in FIG. 4B, the surface-mount inductor 10B is so configured that the premolded bodies 20, 30 are pressed as to inversely deform so as to fill the vacant spaces, and in turn the embedding portions 53 (FIG. 2) are buried in the mold coil 11. The metal terminals 50a, 50b are embedded into the mold coil 11 to a depth corresponding to their thickness, and the lead ends 41a, 41b are embedded into the metal terminals 50a, 50b to a depth equal to their diameter. The thermosetting resin is then completely hardened by heating which result in the surface-mount inductor 10 having a flat surface.

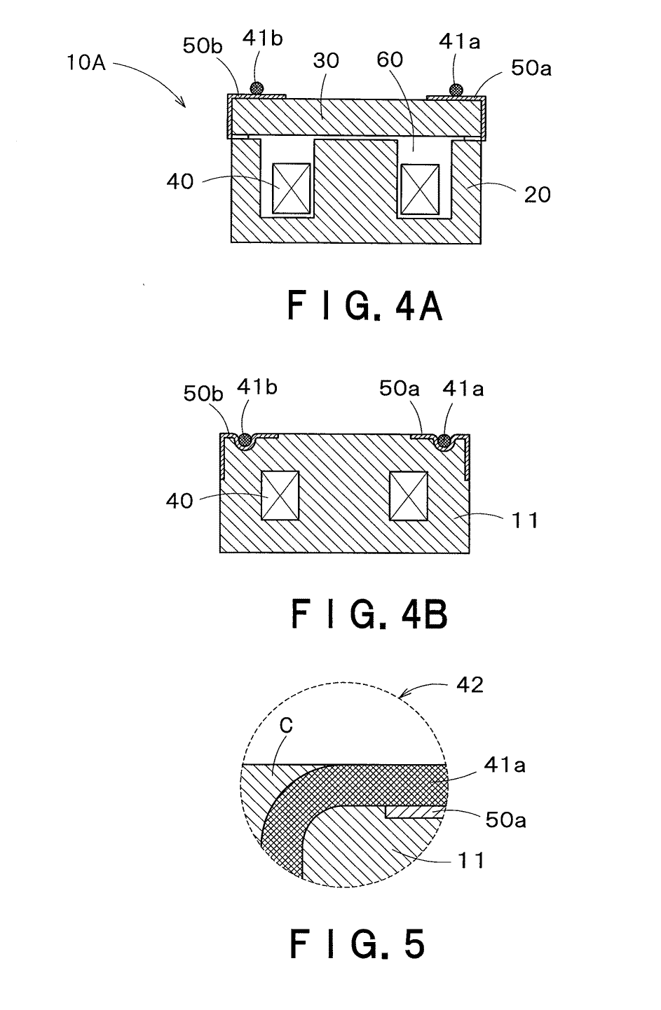

FIG. 5 is an enlarged-sectional view showing the longitudinal section (section B-B in FIG. 3F) around the base portion 42 of the coil 40.

As shown in FIG. 5, “springback” (effect) in the coil 40 is moderated because the outer periphery (“C” in FIG. 5) of the lead ends 41a is filled with resin around the base portion 42.

Since the metal terminals 50a, 50b are preferably thin so that the lead ends 41a, 41b are easily embedded therein, the material of the metal terminals 50a, 50b is preferably soft so as to easily deform when the lead ends 41a, 41b embed therein, tough pitch copper being preferable to phosphor bronze thus the use of relatively soft normalized hardness of less than 1/2H, for example, thin metal terminals 50a, 50b is ideal.

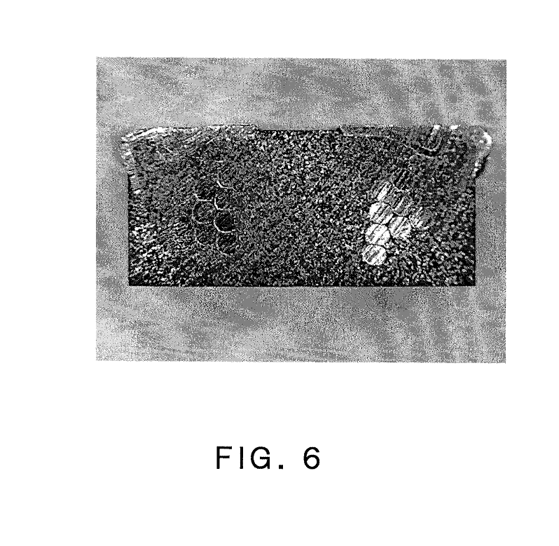

FIG. 6 is a photograph showing the cross sectional view of the surface-mount inductor manufactured by the method described above. The surface-mount inductor is configured to have a 6 mm width×6 mm length×3 mm height, with the diameter of the wire being 0.23 mm, the thickness of the metal terminals made of phosphor bronze being 0.08 mm, and the forming pressure being 10 kg/cm².

As shown in FIG. 6, the lead ends sink into the metal terminals, and the metal terminals are embedded into the surface-mount inductor in their thickness direction.

The surface-mount inductor described above enables preventing the falling off of the metal terminals because the metal terminals are partially embedded in the mold coil, and the state of the connection may be visually recognized.

Further, the metal terminals do not increase the size of the surface-mount inductor because the lead ends sink in the metal terminals and in turn the metal terminals sink in the mold coil.

Furthermore, since the base portions of the lead ends are also embedded in resin, the position shift caused by the spring back before electrically connecting the lead ends to the metal terminals, and the loss of connection between the lead ends and the metal terminals when melting solder to solder on the mounting board, is minimized.

In the process of forming the premolded body, resin from the magnetic resin permeates the premolded body and covers a part of the bottom surface thus obstructing the mounting of the surface-mount inductor. In such a case, the premolded body should be processed by means of barrel polishing and the like to remove the permeating resin.

In addition, the portion embedding the metal terminals may be selected to have, for example, a wide-top shape or a hollow structure in order to provide a surface-mount inductor with metal terminals which do not easily fall off therefrom.

### EXPLANATION OF CODES

10 surface-mount inductor

10A pre-formed surface-mount inductor

10B formed surface-mount inductor

11 mold coil

20, 30 premolded body

21 protruded portion

22a, 22b open portion

31a, 31b chamfered portion

40 coil

41a, 41b lead end

42 base portion

50a, 50b metal terminal

51 bottom surface

52 side surface

53 embedded portion

54 cutout

What is claimed is:

1. A surface-mount inductor including: a coil formed by winding insulated wire and bringing out lead ends therefrom; and a premolded body formed of a mixture of magnetic powder and thermosetting resin to accommodate the coil whose lead ends are brought out therefrom, whereby processing the premolded body by thermopressing to form, the surface-mount inductor comprising
a pair of metal terminals made of deformable plates, and arranged on the outer exposed surface of the premolded body; and
a coil the lead ends of which are embedded in the exposed surface.

2. The surface-mount inductor according to claim 1, wherein
the pair of terminals are embedded in the outer surface of the surface-mount inductor, and
the lead ends are brought out from the bottom surface of the surface-mount inductor, and are laterally embedded in the outer surface of the metal terminals in the radial direction of the lead ends.

3. The surface-mount inductor according to claim 1, wherein
the metal terminals are provided with embedding portions at the ends, and the embedding portions are folded toward the inside of the surface-mount inductor and embedded thereinto.

4. The surface-mount inductor according to claim 1, wherein
the surface-mount inductor is provided with at least a pair of cutouts for bringing out the lead ends therethrough.

5. An intermediary product for manufacturing a surface-mount inductor including: a coil formed by winding insulated wire and bringing out lead ends therefrom; and a premolded body of a mixture of magnetic powder and thermosetting resin which internally accommodates the coil with the lead ends brought out therefrom, whereby processing the premolded body by thermopressing to form: comprising:
a pair of metal terminals deformable by pressing, and arranged on the outer exposed surface of the premolded body; and
a coil the lead ends of which are embedded at the exposed surface.

6. A method for manufacturing a surface-mount inductor comprising the steps of:
mixing magnetic powder and thermosetting resin so as to produce an assemblable premolded body of predetermined shape; and
preparing a coil formed by winding an insulated wire, accommodating the coil inside a multitude of assemblable premolded bodies with the lead ends of the coil brought out therefrom, arranging a pair of metal terminals on the outer surface of the premolded body, arranging a pair of lead ends on the outer surface of the metal terminals, and thermopressing the premolded body to form.
